(19) United States
(12) Patent Application Publication
(10) Pub. No.: US 2006/0235694 A1
(43) Pub. Date: Oct. 19, 2006

(54) Integrating conversational speech into Web browsers

(75) Inventors: Charles W. Cross, Wellington, FL (US); Brien H. Muschett, Palm Beach Gardens, FL (US); Harvey M. Ruback, Loxahatchee, FL (US); Leslie R. Wilson, Boca Raton, FL (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/105,865

(22) Filed: Apr. 14, 2005

(51) Int. Cl. G10L 11/00

(52) U.S. Cl. 704/270.1

(57) ABSTRACT

A method of integrating conversational speech into a multimodal, Web-based processing model can include speech recognizing a user spoken utterance directed to a voice-enabled field of a multimodal markup language document presented within a browser. A statistical grammar can be used to determine a recognition result. The method further can include providing the recognition result to the browser, receiving, within a natural language understanding (NLU) system, the recognition result from the browser, and semantically processing the recognition result to determine a meaning. Accordingly, a next programmatic action to be performed can be selected according to the meaning.

### BACKGROUND

1. Field of the Invention

The present invention relates to multimodal interactions and, more particularly, to performing complex voice interactions using a multimodal browser in accordance with a World Wide Web-based processing model.

2. Description of the Related Art

Multimodal Web-based applications allow simultaneous use of voice and graphical user interface (GUI) interactions. Multimodal applications can be thought of as World Wide Web (Web) applications that have been voice enabled. This typically occurs by adding voice markup language, such as Extensible Voice Markup Language (VoiceXML), to an application coded in a visual markup language such as Hypertext Markup Language (HTML) or Extensible HTML (XHTML). When accessing a multimodal Web-based application, a user can fill in fields, follow links, and perform other operations on a Web page using voice commands. An example of a language that supports multimodal interaction is X+V markup language. X+V stands for XHTML+VoiceXML.

VoiceXML applications rely upon grammar technology to perform speech recognition. Generally, a grammar defines all the allowable utterances that the speech-enabled application can recognize. Incoming audio is matched, by the speech processing engine, to a grammar specifying the list of allowable utterances. Conventional VoiceXML applications use grammars formatted according to Backus-Naur Form (BNF). These grammars are compiled into a binary format for use by the speech processing engine. The Speech Recognition Grammar Specification (SRGS), currently at version 1.0 and promulgated by the World Wide Web Consortium (W3C), specifies the variety of BNF grammar to be used with VoiceXML applications and/or multimodal browser configurations.

Often, however, there is a need for conducting more complex voice interactions with a user than can be handled using a BNF grammar. Such grammars are unable to support, or determine meaning from, voice interactions having a large number of utterances or a complex language structure that may require multiple question and answer interactions. To better process complex voice interactions, statistical grammars are needed in conjunction with an understanding mechanism to determine a meaning from the interactions.

Traditionally, advanced speech processing which relies upon statistical grammars has been reserved for use in speech-only systems. For example, advanced speech processing has been used in the context of interactive voice response (IVR) systems and other telephony applications. As such, this technology has been built around a voice processing model which is different from a Web-based approach or model.

Statistically-based conversational applications built around the voice processing model can be complicated and expensive to build. Such applications rely upon sophisticated servers and application logic to determine meaning from speech and/or text and to determine what action to take based upon received user input. Within these applications, understanding of complex sentence structures and conversational interaction are sometimes required before the user can move to the next step in the application. This requires a conversational processing model which specifies what information has to be ascertained before moving to the next step of the application.

The voice processing model used for conversational applications lacks the ability to synchronize conversational interactions with a GUI. Prior attempts to make conversational applications multimodal did not allow GUI and voice to be mixed in a given page of the application. This has been a limitation of the applications, which often leads to user confusion when using a multimodal interface.

It would be beneficial to integrate statistical grammars and conversational understanding into a multimodal browser thereby taking advantage of the efficiencies available from Web-based processing models.

### SUMMARY OF THE INVENTION

The present invention provides a solution for performing complex voice interactions in a multimodal environment. More particularly, the inventive arrangements disclosed herein integrate statistical grammars and conversational understanding into a World Wide Web (Web) centric model. One embodiment of the present invention can include a method of integrating conversational speech into a Web-based processing model. The method can include speech recognizing a user spoken utterance directed to a voice-enabled field of a multimodal markup language document presented within a browser. The user spoken utterance can be speech recognized using a statistical grammar to determine a recognition result. The recognition result can be provided to the browser. Within a natural language understanding system (NLU), the recognition result can be received from the browser. The recognition result can be semantically processed to determine a meaning and a next programmatic action to be performed can be selected according to the meaning.

Another embodiment of the present invention can include a system for processing multimodal interactions including conversational speech using a Web-based processing model. The system can include a multimodal server configured to process a multimodal markup language document. The multimodal server can store non-visual portions of the multimodal markup language document such that the multimodal server provides visual portions of the multimodal markup language document to a client browser. The system further can include a voice server configured to perform automatic speech recognition upon a user spoken utterance directed to a voice-enabled field of the multimodal markup language document. The voice server can utilize a statistical grammar to process the user spoken utterance directed to the voice-enabled field. The client browser can be provided with a result from the automatic speech recognition.

A conversational server and an application server also can be included in the system. The conversational server can be configured to semantically process the result of the automatic speech recognition to determine a meaning that is provided to a Web server. The speech recognition result to be semantically processed can be provided to the conversational server from the client browser via the Web server. The application server can be configured to provide data responsive to an instruction from the Web server. The Web server can issue the instruction according to the meaning.

Other embodiments of the present invention can include a machine readable storage being programmed to cause a machine to perform the various steps described herein.

### BRIEF DESCRIPTION OF THE DRAWINGS

There are shown in the drawings, embodiments which are presently preferred; it being understood, however, that the invention is not limited to the precise arrangements and instrumentalities shown.

FIG. 1 is a schematic diagram illustrating a system for performing complex voice interactions using a World Wide Web (Web) based processing model in accordance with one embodiment of the present invention.

FIG. 2 is a schematic diagram illustrating a multimodal, Web-based processing model capable of performing complex voice interactions in accordance with the inventive arrangements disclosed herein.

FIG. 3 is a pictorial illustration of a multimodal interface generated from a multimodal markup language document presented within a browser in accordance with one embodiment of the present invention.

FIG. 4 is a pictorial illustration of the multimodal interface of FIG. 3 after being updated to indicate recognized and/or processed user input(s) in accordance with another embodiment of the present invention.

### DETAILED DESCRIPTION OF THE INVENTION

The present invention provides a solution for incorporating more advanced speech processing capabilities into multimodal browsers. More particularly, statistical grammars and natural language understanding (NLU) processing can be incorporated into a World Wide Web (Web) based processing model through a tightly synchronized multimodal user interface. The Web-based processing model facilitates the collection of information through a Web-browser. This information, for example user speech and input collected from graphical user interface (GUI) components, can be provided to a Web-based application for processing. The present invention provides a mechanism for performing and coordinating more complex voice interactions, whether complex user utterances and/or question and answer type interactions.

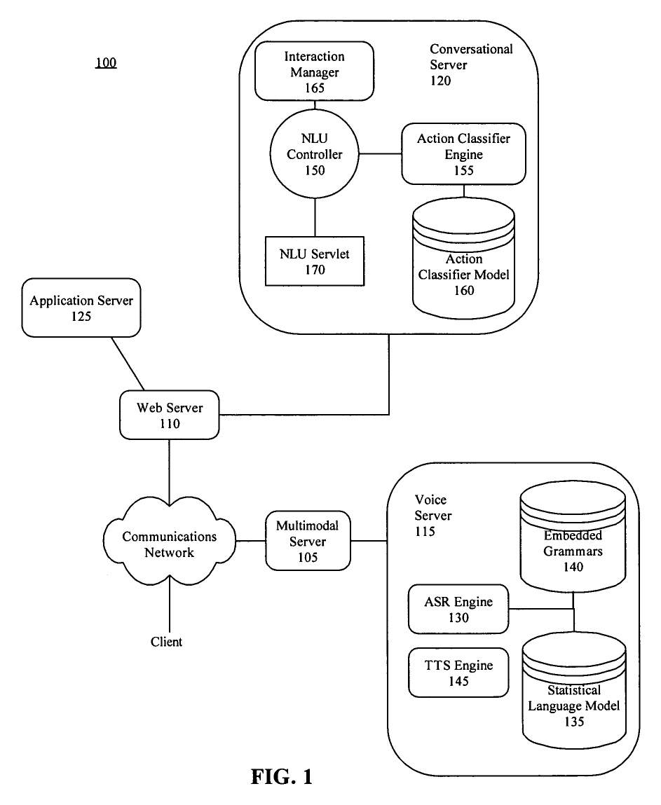

FIG. 1 is a schematic diagram illustrating a system 100 for performing complex voice interactions based upon a Web-based processing model in accordance with one embodiment of the present invention. As shown, system 100 can include a multimodal server 105, a Web server 110, a voice server 115, a conversational server 120, and an application server 125.

The multimodal server 105, the Web server 110, the voice server 115, the conversational server 120, and the application server 125 each can be implemented as a computer program, or a collection of computer programs, executing within suitable information processing systems. While one or more of the servers can execute on a same information processing system, the servers can be implemented in a distributed fashion such that one or more, or each, executes within a different computing system. In the event that more than one computing system is used, each computing system can be interconnected via a communication network, whether a local area network (LAN), a wide area network (WAN), an Intranet, the Internet, the Web, or the like.

The system 100 can communicate with a remotely located client (not shown). The client can be implemented as a computer program such as a browser executing within a suitable information processing system. In one embodiment, the browser can be a multimodal browser. The information processing system can be implemented as a mobile phone, a personal digital assistant, a laptop computer, a conventional desktop computer system, or any other suitable communication device capable of executing a browser and having audio processing capabilities for capturing, sending, receiving, and playing audio. The client can communicate with the system 100 via any of a variety of different network connections as described herein, as well as wireless networks, whether short or long range, including mobile telephony networks.

The multimodal server 105 can include a markup language interpreter that is capable of interpreting or executing visual markup language and voice markup language. In accordance with one embodiment, the markup language interpreter can execute Extensible Hypertext Markup Language (XHTML) and Voice Extensible Markup Language (VoiceXML). In another embodiment, the markup language interpreter can execute XHTML+VoiceXML (X+V) markup language. As such, the multimodal server 105 can send and receive information using the Hypertext Transfer Protocol.

The Web server 110 can store a collection of markup language pages that can be provided to clients upon request. These markup language pages can include visual markup language pages, voice markup language pages, and multimodal markup language (MML) pages, i.e. X+V markup language pages. Notwithstanding, the Web server 110 also can dynamically create markup language pages as may be required, for example under the direction of the application server 125.

The voice server 115 can provide speech processing capabilities. As shown, the voice server 115 can include an automatic speech recognition (ASR) engine 130, which can convert speech-to-text using a statistical language model 135 and grammars 140 (collectively “statistical grammar”). Though not shown, the ASR engine 130 also can include BNF style grammars which can be used for speech recognition. Through the use of statistical language model 135, however, the ASR engine 130 can determine more information from a user spoken utterance than the words that were spoken as would be the case with a BNF grammar. While the grammar 140 can define the words that are recognizable to the ASR engine 130, the statistical language model 135 enables the ASR engine 130 to determine information pertaining to the structure of the user spoken utterance.

The structural information can be expressed as a collection of one or more tokens associated with the user spoken utterance. In one aspect, a token is the smallest independent unit of meaning of a program as defined either by a parser or a lexical analyzer. A token can contain data, a language keyword, an identifier, or other parts of language syntax. The tokens can specify, for example, the grammatical structure of the utterance, parts of speech for recognized words, and the like. This tokenization can provide the structural information relating to the user spoken utterance. Accordingly, the ASR 130 can convert a user spoken utterance to text and provide the speech recognized text and/or a tokenized representation of the user spoken utterance as output, i.e. a recognition result. The voice server 115 further can include a text-to-speech (TTS) engine 145 for generating synthetic speech from text.

The conversational server 120 can determine meaning from user spoken utterances. More particularly, once user speech is processed by the voice server 115, the recognized text and/or the tokenized representation of the user spoken utterance ultimately can be provided to the conversational server 120. In one embodiment, in accordance with the request-response Web processing model, this information first can be forwarded to the browser within the client device. The recognition result, prior to being provided to the browser, however, can be provided to the multimodal server, which can parse the results to determine words and/or values which are inputs to data entry mechanisms of an MML document presented within the client browser. In any case, by providing this data to the browser, the graphical user interface (GUI) can be updated, or synchronized, to reflect the user's processed voice inputs.

The browser in the client device then can forward the recognized text, tokenized representation, and parsed data back to the conversational server 120 for processing. Notably, because of the multimodal nature of the system, any other information that may be specified by a user through GUI elements, for example using a pointer or other non-voice input mechanism, in the client browser also can be provided with, or as part of, the recognition result. Notably, this allows a significant amount of multimodal information, whether derived from user spoken utterances, GUI inputs, or the like to be provided to the conversational server 120.

The conversational server 120 can semantically process received information to determine a user intended meaning. Accordingly, the conversational server 120 can include a natural language understanding (NLU) controller 150, an action classifier engine 155, an action classifier model 160, and an interaction manager 165. The NLU controller 150 can coordinate the activities of each of the components included in the conversational server 120. The action classifier 155, using the action classifier model 160, can analyze received text, the tokenized representation of the user spoken utterance, as well as any other information received from the client browser, and determine a meaning and suggested action. Actions are the categories into which each request a user makes can be sorted. The actions are defined by application developers within the action classifier model 160. The integration manager 165 can coordinate communications with any applications executing within the application server 125 to which data is being provided or from which data is being received.

The conversational server 120 further can include an NLU servlet 170 which can dynamically render markup language pages. In one embodiment, the NLU servlet 170 can render voice markup language such as VoiceXML using a dynamic Web content creation technology such as JavaServer Pages (JSP). Those skilled in the art will recognize, however, that other dynamic content creation technologies also can be used and that the present invention is not limited to the examples provided. In any case, the meaning determined by the conversational server 120 can be provided to the Web server 110.

The Web server 110, in turn, provides instructions and any necessary data, in terms of user inputs, tokenized results, and the like, to the application server 125. The application server 125 can execute one or more application programs such as a call routing application, a data retrieval application, or the like. If a meaning and clear action is determined by the conversational server 120, the Web server 110 can provide the appropriate instructions and data to the application server 125. If the meaning is unclear, the Web server 110 can cause flurther MML documents to be sent to the browser to collect further clarifying information, thereby supporting a more complex question and answer style of interaction. If the meaning is clear, the requested information can be provided to the browser or the requested function can be performed.

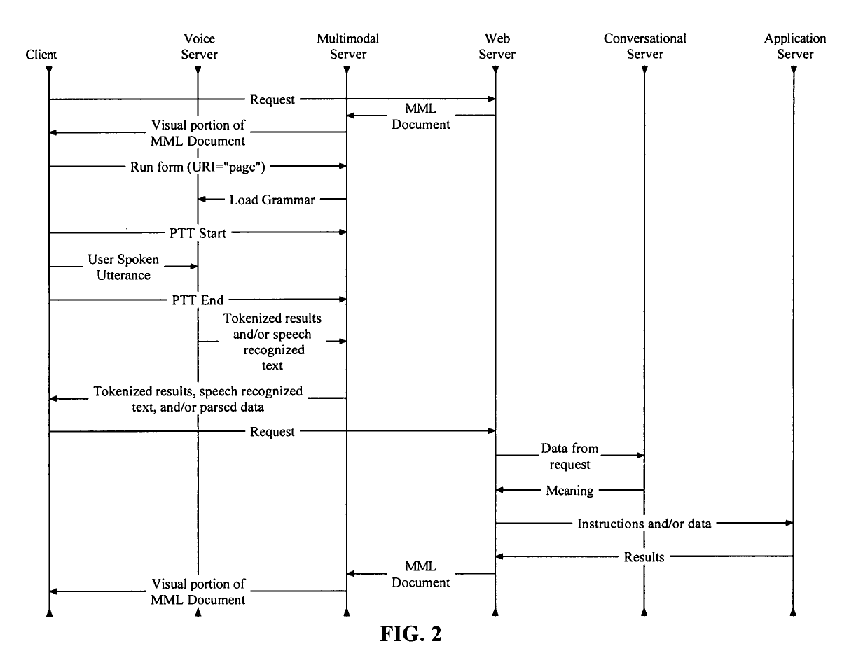

FIG. 2 is a schematic diagram illustrating a multimodal, Web-based processing model in accordance with the inventive arrangements disclosed herein. The multimodal processing model describes the messaging, communications, and actions that can take place between various components of a multimodal system. In accordance with the embodiment illustrated in FIG. 1, interactions between a client, a voice server, a multimodal server, a Web-based server, a conversational server, and an application server are illustrated.

The messaging illustrated in FIG. 2 will be described in the context of a weather application. It should be appreciated, however, that the present invention can be used to implement any of a variety of different applications. Accordingly, while the examples discussed herein help to provide a deeper understanding of the present invention, the examples are not to be construed as limitations with respect to the scope of the present invention.

As shown in FIG. 2, the client can issue a request for an MML page or document. The request can be sent to the Web server and specify a particular universal resource locator or identifier as the case may be. The request can specify a particular server and provide one or more attributes. For example, the user of the client browser can request a markup language document which provides information, such as weather information, for a particular location. In that case, the user can provide an attribute with the request that designates the city in which the user is located, such as “Boca” or “Boca Raton”. The requested markup language document can be an MML document.

The Web server can retrieve the requested MML document or dynamically generate such a page, which then can be forwarded to the multimodal server. The multimodal server, or a proxy for the multimodal server, can intercept the MML document sent from the Web server. The multimodal server can separate the components of the MML document such that visual portions are forwarded to the client browser. Portions associated with voice processing can be stored in a data repository in the multimodal server.

In the case where the MML document is an X+V document, the XHTML portions specifying the visual interface to be presented when rendered in the client browser can be forwarded to the client. The VoiceXML portions can be stored within the repository in the multimodal server. Though separated, the XHTML and VoiceXML components of the MML document can remain associated with one another such that a user spoken utterance received from the client browser can be processed using the VoiceXML stored in the multimodal server repository.

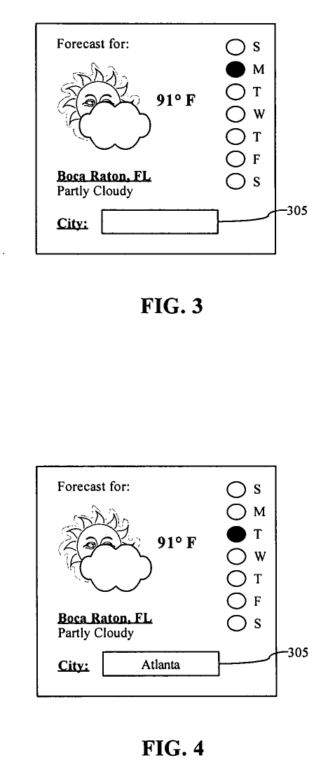

In reference to the weather application example, the returned page can be a multimodal page such as the one illustrated in FIG. 3, having visual information specifying weather conditions for Boca Raton. The page can include a voice-enabled field 305 for receiving a user spoken utterance specifying another city of interest, i.e. one for which the user wishes to obtain weather information.

Upon receiving the visual portion of the MML document, the client browser can load and execute it. The client browser further can send a notification to the multimodal server indicating that the visual portion of the MML document has been loaded. This notification can serve as an instruction to the multimodal browser to run the voice markup language portion, i.e. a VoiceXML coded form, of the MML document that was previously stored in the repository. Accordingly, an MML interpreter within the multimodal server can be instantiated.

Upon receiving the notification from the client browser, the multimodal server can establish a session with the voice server. That is, the MML interpreter, i.e. an X+V interpreter, can establish the session. In one embodiment, the session can be established using Media Resource Control Protocol (MRCP), which is a protocol designed to address the need for client control of media processing resources such as ASR and TTS engines. As different protocols can be used, it should be appreciated that the invention is not to be limited to the use of any particular protocol.

In any case, the multimodal server can instruct the voice server to load a grammar that is specified by the voice markup language now loaded into the MML interpreter. In one embodiment, the grammar that is associated with an active voice-enabled field presented within the client browser can be loaded. This grammar can be any of a variety of grammars, whether BNF, another grammar specified by the Speech Recognition Grammar Specification, or a statistical grammar. Accordingly, the multimodal server can select the specific grammar indicated by the voice markup language associated with the displayed voice-enabled field.

It should be appreciated that an MML document can specify more than one voice-enabled field. Each such field can be associated with a particular grammar, or more than one field can be associated with a same grammar. Regardless, different voice-enabled fields within the same MML document can be associated with different types of grammars. Thus, for a given voice-enabled field, the appropriate grammar can be selected from a plurality of grammars to process user spoken utterances directed to that field. Continuing with the previous example, the voice markup language stored in the multimodal server repository can indicate that field 305, for instance, is associated with a statistical grammar. Accordingly, audio directed to input field 305 can be processed with the statistical grammar.

At some point, a push-to-talk (PTT) start notification from the client can be received in the multimodal server. The PTT start notification can be activated by a user selecting a button on the client device, typically a physical button. The PTT start notification signifies that the user of the client browser will be speaking and that a user spoken utterance will be forthcoming. The user speech can be directed, for example, to field 305. Accordingly, the user of the client browser can begin speaking. The user spoken utterance can be provided from the client browser to the voice server.

The voice server can perform ASR on the user spoken utterance using the statistical grammar. The voice server can continue to perform ASR until such time as a PTT end notification is received by the multimodal server. That is, the multimodal server can notify the voice server to discontinue ASR when the PTT function terminates.

If the user spoken utterance is, for example, “What will the weather be in Atlanta the next day?”, the ASR engine can convert the user spoken utterance to a textual representation. Further, the ASR engine can determine one or more tokens relating to the user spoken utterance. Such tokens can indicate the part of speech of individual words and also convey the grammatical structure of the text representation of the user spoken utterance by identifying phrases, sentence structures, actors, locations, dates, and the like. The grammatical structure indicated by the tokens can specify that Atlanta is the city of inquiry and that the time for which data is sought is the next day.

Thus, two of the tokens determined by the ASR can be, for example, Atlanta and 3. The token Atlanta in this case is the city for which weather information is being sought. The token 3 indicates the particular day of the week for which weather information is being sought. As shown in the GUI of FIG. 3, the current day is Monday, which can translate to the numerical value of 2 in relation to the days of the week, where Sunday is day one. Accordingly, the ASR engine has interpreted the phrase next day to mean Tuesday which corresponds with a token of 3.

The speech recognized text and the tokenized representation can be provided to the multimodal server. The MML interpreter, under the direction of the voice markup language, can parse the recognition result of the ASR engine to select Atlanta and 3 from the entirety of the provided recognized text and tokens. Atlanta and 3 are considered to be the input needed from the user in relation to the page displayed in FIG. 3. That is, the multimodal server, in executing the voice portions of the MML document, parses the received text and tokenized representation to determine text corresponding to a voice- enabled input field, i.e. field 305, and the day of the week radio buttons.

The multimodal server can provide the speech recognized text, the tokenized representation, and/or any results obtained from the parsing operation to the client browser. Further, the client browser can be instructed to fill in any fields using the provided data. Having received the recognized text, the tokenized representation of the user spoken utterance, and parsed data (form values), the client browser can update the displayed page to present one or more of the items of information received. The fields, or input mechanisms of the GUI portion of the MML document, can be filled in with the received information. FIG. 4 illustrates an updated version of the GUI of FIG. 3, where the received text, tokenized information, and parsed data have been used to fill in portions of the GUI. As shown, field 305 now includes the text “Atlanta” and Tuesday has been selected. If desired, however, the entirety of the speech recognized text can be displayed in field 305.

The voice interaction described thus far is complex in nature as more than one input was detected from a single user spoken utterance. That is, both the city and day of the week were determined from a single user spoken utterance. Notwithstanding, it should be appreciated that the multimodal nature of the invention also allows the user to enter information using GUI elements. For example, had the user not indicated the day for which weather information was desired in the user spoken utterance, the user could have selected Tuesday using some sort of pointing device or key commands. Still, the user may select another day such as Wednesday if so desired using a pointing device, or by speaking to the voice-enabled field of the updated GUI shown in FIG. 4.

In any case, the browser client can send a request to the Web server. The request can specify the recognition result. The recognition result can include the speech recognized text, the tokenized representation, the parsed data, or any combination thereof. Accordingly, the request can specify information for each field of the presented GUI, in this case the city and day for which weather information is desired. In addition, because the page displayed in the client browser is multimodal in nature, the request further can specify additional data that was input by the user through one or more GUI elements using means other than speech, i.e. a pointer or stylus. Such elements can include, but are not limited to, radio buttons, drop down menus, check boxes, other text entry methods, or the like.

The browser client request further can include a URI or URL specifying a servlet or other application. In this case, the servlet can be a weather service. The weather servlet, located within the Web server, can receive the information and forward it to the conversational server for further processing. Within the conversational server, an NLU servlet can semantically process the results to determine the meaning of the information provided. Notably, the conversational server can be provided with speech recognized text, the tokenized representation of the user spoken utterance, any form values as determined from the multimodal server parsing operation, as well as any other data entered into the page displayed in the client browser through GUI elements.

Accordingly, the conversational server has a significant amount of information for performing semantic processing to determine a user intended meaning. This information can be multimodal in nature as part of the information can be derived from a user spoken utterance and other parts of the information can be obtained through non-voice means. The conversational server can send its results, i.e. the meaning and/or a predicted action that is desired by the user, to the Web server for further processing.

In cases where the user meaning or desire is clear, the Web server can provide actions and/or instructions to the application server. The communication from the Web server can specify a particular application as the target or recipient, an instruction, and any data that might be required by the application to execute the instruction. In this case, for example, the Web server can send a notification that the user desires weather information for the city of Atlanta for Tuesday. If the user meaning is unclear, the Web server can cause flurther MML documents to be sent to the client browser in an attempt to clarify the user's intended meaning.

The application program can include logic for acting upon the instructions and data provided by the Web server. Continuing with the previous example, the application server can query a back-end database having weather information to obtain the user requested forecast for Atlanta on Tuesday. This information can be provided to the Web server which can generate another MML document to be sent to the client browser. The MML document can include the requested weather information.

When the MML document is generated by the Web server, as previously described, the MML document can be intercepted by the multimodal server. The multimodal server again can separate the visual components from the voice components of the MML document. Visual components can be forwarded to the client browser while the related voice components can be stored in the repository of the multimodal server.

FIGS. 24 illustrate various embodiments for incorporating complex voice interactions into a Web-based processing model. It should be appreciated that while the example dealt with determining a user's intent after a single complex voice interaction, that more complicated scenarios are possible. For example, it can be the case that the user spoken utterance does not clearly indicate what is desired by the user. Accordingly, the conversational server and Web server can determine a course of action to seek clarification from the user. The MML document provided to the client browser would, in that case, seek the needed clarification. Complex voice interactions can continue through multiple iterations, with each iteration seeking further clarification from the user until such time that the user intent is determined.

The present invention provides a solution for including statistical-based conversational technology within multimodal Web browsers. In accordance with the inventive arrangements disclosed herein, the present invention relies upon a Web-based processing model rather than a voice processing model. The present invention further allows multimodal applications to be run on systems with and without statistical conversational technology.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which, when loaded in a computer system, is able to carry out these methods. Computer program, software application, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of integrating conversational speech into a multimodal, Web-based processing model, said method comprising:
speech recognizing a user spoken utterance directed to a voice-enabled field of a multimodal markup language document presented within a browser using a statistical grammar to determine a recognition result;
providing the recognition result to the browser;
receiving, within a natural language understanding (NLU) system, the recognition result from the browser;
semantically processing the recognition result to determine a meaning; and
selecting a next programmatic action to be performed according to the meaning.

2. The method of claim 1, further comprising, prior to said speech recognizing step, sending at least a visual portion of the multimodal markup language document to the browser, wherein the statistical grammar is associated with the voice-enabled field.

3. The method of claim 1, further comprising, responsive to a notification that the requesting browser is executing at least a visual portion of the multimodal markup language document, loading the statistical grammar for processing user speech directed to the voice-enabled field.

4. The method of claim 1, wherein the recognition result comprises speech recognized text.

5. The method of claim 1, wherein the recognition result comprises a tokenized representation of the user spoken utterance.

6. The method of claim 1, wherein the recognition result comprises at least one of speech recognized text and a tokenized representation of the user spoken utterance, said speech recognizing step further comprising parsing the recognition result to determine data for at least one input element of the multimodal markup language document presented within the browser, such that the data is used in said semantically processing step with the recognition result.

7. The method of claim 1, further comprising receiving, within the NLU system, additional data that was entered, through a non-voice user input, into the multimodal markup language document presented by the browser, wherein said semantically processing step is performed using the recognition result and the additional data.

8. The method of claim 1, said determining step comprising generating a next multimodal markup language document that is provided to the browser.

9. A system for processing multimodal interactions including conversational speech using a Web-based processing model, said system comprising:
a multimodal server configured to process a multimodal markup language document and store non-visual portions of the multimodal markup language document, wherein the multimodal server provides visual portions of the multimodal markup language document to a client browser;
a voice server configured to perform automatic speech recognition upon a user spoken utterance directed to a voice-enabled field of the multimodal markup language document, wherein said voice server utilizes a statistical grammar to process the user spoken utterance directed to the voice-enabled field, wherein the client browser is provided with a result from the automatic speech recognition;
a conversational server configured to semantically process the result of the automatic speech recognition to determine a meaning that is provided to a Web server, wherein the conversational server receives the result of the automatic speech recognition to be semantically processed from the client browser via the Web server; and
an application server configured to provide data responsive to an instruction from the Web server, wherein the Web server issues the instruction according to the meaning.

10. The system of claim 9, wherein the conversational server further is provided non- voice user input originating from at least one graphical user interface element of the multimodal markup language document such that the meaning is determined according to the non-voice user input and the result of the automatic speech recognition.

11. The system of claim 9, wherein the result of the automatic speech recognition comprises a tokenized representation of the user spoken utterance and at least one of speech recognized text derived from the user spoken utterance and data derived from the user spoken utterance that corresponds to at least one input mechanism of a visual portion of the multimodal markup language document.

12. The system of claim 9, wherein the Web server generates a multimodal markup language document to be provided to the client browser, wherein the multimodal markup language document comprises data obtained from the application server.

13. A machine readable storage, having stored thereon a computer program having a plurality of code sections executable by a machine for causing the machine to perform the steps of:
speech recognizing a user spoken utterance directed to a voice-enabled field of a multimodal markup language document presented within a browser using a statistical grammar to determine a recognition result;
providing the recognition result to the browser;
receiving, within a natural language understanding (NLU) system, the recognition result from the browser;
semantically processing the recognition result to determine a meaning; and
selecting a next programmatic action to be performed according to the meaning.

14. The machine readable storage of claim 13, further comprising, prior to said speech recognizing step, sending at least a visual portion of the multimodal markup language document to the browser, wherein the statistical grammar is associated with the voice-enabled field.

15. The machine readable storage of claim 13, further comprising, responsive to a notification that the requesting browser is executing at least a visual portion of the multimodal markup language document, loading the statistical grammar for processing user speech directed to the voice-enabled field.

16. The machine readable storage of claim 13, wherein the recognition result comprises speech recognized text.

17. The machine readable storage of claim 13, wherein the recognition result comprises a tokenized representation of the user spoken utterance.

18. The machine readable storage of claim 13, wherein the recognition result comprises at least one of speech recognized text and a tokenized representation of the user spoken utterance, said speech recognizing step further comprising parsing the recognition result to determine data for at least one input element of the multimodal markup language document presented within the browser, such that the data is used in said semantically processing step with the recognition result.

19. The machine readable storage of claim 13, further comprising receiving, within the NLU system, additional data that was entered, through a non-voice user input, into the multimodal markup language document presented by the browser, wherein said semantically processing step is performed using the recognition result and the additional data.

20. The machine readable storage of claim 13, said determining step comprising generating a next multimodal markup language document that is provided to the browser.
